(19) United States
(12) Patent Application Publication
(10) Pub. No.: US 2004/0199579 A1
(43) Pub. Date: Oct. 7, 2004

(54) Collaboration bus apparatus and method

(76) Inventor: Phillip Edward Straw, El Granada, CA (US)

Correspondence Address: Anthony T. Cascio, Suite 314, 423 Broadway Ave., Millbrae, CA, 94030, US

(21) Appl. No.: 10/405,921

(22) Filed: Apr. 1, 2003

(51) Int. Cl. G06F 15/16

(52) U.S. Cl. 709/204; 709/230

(57) ABSTRACT

Each node on the network is in collaboration with each other node through a protocol. The protocol at each node passively observes the network traffic. Upon specific predetermined patterns in the network traffic being recognized by the protocol at any one node, a report is generated based on such pattern at such node. This report may then be shared with each other node, which should have recognized the same pattern. If the report at any two nodes does not match, an error is generated based on the discrepancy contained in the mismatched report. The protocol at the node at which the error occurs can now access a knowledge base to determine if such similar error has occurred in the past. If such error is found, the protocol at the node in error can reconfigure the node to eliminate such error.

### BACKGROUND OF THE INVENTION

The present invention relates generally to computer network apparatus and methods and more particularly to a novel method and apparatus in which network devices collaborate.

In computer networks, such as a local area network (LAN), various nodes may communicate with each other over the network bus. Typically, the nodes include computers, printers and routers. For example, several computers may be in communication with the network bus and share a single printer also in communication with the network bus. The router provides a gateway between the local network and another network, such as a wide area network (WAN), for example, the Internet. Other network devices, such as workgroup hubs and switches, are part of the network bus and not nodes.

LAN's have become relatively common in the commercial, government and educational settings. For example, a company may have several locations at which it conducts various aspects of its business. Different business groups within the company, or different buildings, for example, may each have their own LAN, and each LAN connected through a gateway to a WAN such that company wide communications for the sharing of digital information are possible.

Typically, these commercial LAN's require equipment of various manufacture, operating systems and interfaces to communicate seamlessly with each other, such that the LAN itself becomes transparent to the individual users communicating data. To enable such communications, each of the nodes on the LAN contains a protocol stack, with each layer in the stack providing functions of encapsulation and addressing, as is well known.

The popularity of personal computing has resulted in the need for multiple computers to communicate with each other over a LAN, not only in the commercial and educational institutions, but also frequently in the residential market. Many private residences are now equipped with several personal computers. For example in one such exemplary residence, one computer may be set up in a home office, another computer in a family room or den, and other computers set up in the bedrooms of the home.

The home office computer may be used to manage household finances and also be used as a satellite office for at-home work. The den computer may be for gaming and general entertainment purposes. The bedroom computers may be used for homework and educational purposes. Each of these computers typically requires a connection to the internet, such that at-home work can be transmitted to a place of employment, interactive gaming with other Internet users can occur, and educational tasks can be downloaded and transmitted to an educational institution.

Without a LAN, either each computer in the exemplary residence must have its own Internet connection on its own telephone line, or one computer has the connection and the data needed to be transmitted or received physically carried between the connected computer and the other computers on removable disks. Although it is possible for each computer to have its own Internet connection on a single shared telephone line, this scenario would require that only one computer may be connected at any one time to the Internet. Furthermore, each computer must have its own printer, otherwise files for printing must also be carried on removable disks to the computer with print capability.

The solution for the exemplary residence is the same solution that commercial, government and educational institutions have used, the LAN. The computers of the exemplary residence, if connected together over a network bus in a LAN can now share printers, internal resources such as disk space, and share a single Internet connection with such connection being available to each computer at any time.

However, whereas the commercial, governmental and educational institutions regularly employ the services of network specialists to set up and maintain the network, such services are usually financially prohibitive for the exemplary residence. Although low cost LAN hardware is readily available for residential use, and its installation within the skill of non-specialist, the ability to make such hardware operate with different devices that may be found in the exemplary residence may be beyond the skill of the general residential user.

Typical problems arise for the general residential user after the initial set up of the LAN. For example, new computer or print server may be added to the network in addition to existing network devices or in replacement of older equipment. The general residential user may have difficulty in having the new equipment communicate with one or more nodes on the residential LAN, or have the existing nodes recognize the addition of a new node. Although the existing LAN hardware commercially available for residential use is generally advertised as “plug-and-play”, such hardware usually requires some initial set-up configuration and changes to be made at other network devices.

### SUMMARY OF THE INVENTION

The present invention is directed to collaboration bus apparatus and methods that enable nodes of a LAN to share knowledge between them as to the state of the network. This feature of sharing knowledge of the network state allows each node to track changes on the LAN and to make configuration changes as needed. Accordingly, the general residential user is advantageously relieved of the burden of specific networking expertise.

According to the present invention, a protocol is installed at each network node. Through this protocol, each node on the network is in collaboration with each other node. The protocol at each node passively observes the network traffic. Upon specific predetermined patterns in the network traffic being recognized by the protocol at any one node, a report is generated based on such pattern at such node. This report may then be shared with each other node, which should have recognized the same pattern. If the report at any two nodes does not match, an error is generated based on the discrepancy contained in the mismatched report. The protocol at the node at which the error occurs can now access a knowledge base to determine if such similar error has occurred in the past. If such error is found, the protocol at the node in error can reconfigure the node to eliminate such error.

In another embodiment, the process of accessing the knowledge base may be reiterative. In yet another embodiment, a master database may be provided on the Internet wherein one such LAN at each of a plurality of locations can access a shared knowledge base.

Each of the nodes with the protocol installed thus becomes a state machine, with the network being a collection of states. Each node thus has a sense of what state it is in and how the state should transition based on the recognized pattern or signature. Furthermore, each node can inject packets into the network to effect what is seen and define new patterns and signatures.

These and other objects, advantages and features of the present invention will become readily apparent to those skilled in the art form a study of the following Description of the Exemplary Preferred Embodiments when read in conjunction with the attached Drawing and appended Claims.

### BRIEF DESCRIPTION OF THE DRAWING

FIG. 1 is a schematic block diagram of the network of useful for practicing the methods of the present invention.

FIG. 2 is a flowchart illustrative of the methods of one embodiment of the present invention.

FIG. 3 is a flowchart illustrative of a step of FIG. 2.

### DESCRIPTION OF THE EXEMPLARY PREFERRED EMBODIMENTS

As will be described in greater detail hereinbelow, the collaboration bus of the present invention is an overlay network on a TCP/IP network that is used by network nodes to communicate and cooperate. The collaboration bus is a communications protocol that is distinguished from known network protocols in two significant respects. The collaboration bus protocols allow for the instantiation of multiple perspectives wherein distinct nodes on the network provide their own individual views of network status and activity, and collaboration wherein the differing perspectives of individual nodes are communicated to other nodes on the network such that information of these perspectives may be used to diagnose network problems with an accuracy not possible in single perspective systems.

Among the collaboration applications made possible are installation, configuration, diagnosis, repair, upgrade, and security. Other possible applications include file sharing, print sharing, application sharing, and distributed processing. Various functions of the collaboration bus will also become known from the following description.

One such function is an announcement wherein each node multicasts information about itself Each node thus can tell each other node its view of the network. A corresponding function is scanning wherein each node listens for multicast announcements from the other nodes. The information derived from scanning may also be used by the scanning node to develop its own view of the network state for the multicast message. In addition to scanning, each node may also actively listen for signatures in the network traffic, such signatures being patterns of packets or patterns within packets, the signatures may then be compared or referenced to a library of known signatures to derive further information of the network state.

Other functions include a proxy work request and proxy work response. A node may request that another specific node (or itself using the collaboration bus) perform a function by sending a unicast message to the specific node. The message includes the task to be performed. It is assumed that the requestor node knows which node it wants to do the function.

The node at which the request is made determines whether it has the code available to do the job. If so, it performs the function and sends results. It may also send progress updates (percentages) while the job is being performed. Each proxy work request refers to a “job” (such as ping xyz). All jobs must be validated or “signed.” When a proxy work request is made, the JAVA virtual machine confirms that the job has been validated.

If the node at which the request is made does not have the code, it does a multicast to the network asking if any other node has the code. If code is found in the network at another node, the node at which the request is made retrieves the code from the other node at which the code is located and then performs the work. If the code is not in the network, the at which the request is made may go to a wide area network to find the code at a specified server.

Connections in from the remote server are strongly authenticated. A permission switch set locally determines whether the remote server connection is allowed. Typically, the default is no. Outbound connections are less strongly authenticated, because it is assumed that they involve an activity that is pre-defined and possibly monitored. The remote node can issue proxy work requests to the local nodes; however, the local nodes cannot issue proxy work requests to the remote node.

Set forth above is a general overview of an exemplary collaboration bus according to the present invention. Such overview is not intended to be limiting upon the present invention. Following is a description of exemplary preferred embodiments of the present invention.

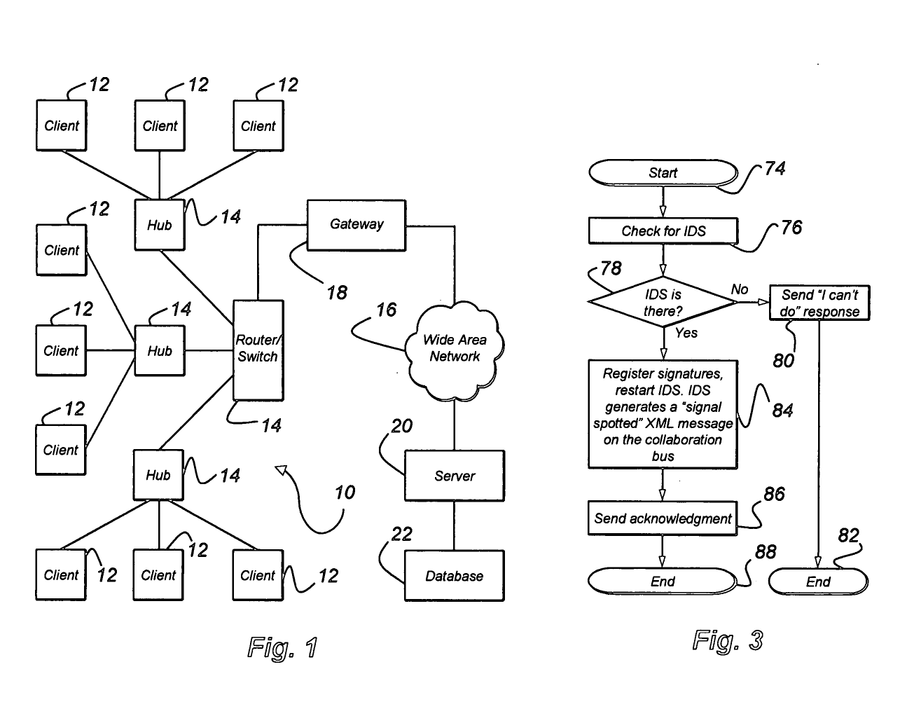

Referring now to FIG. 1, there is shown the schematic block diagram of a local area network 10 including a plurality of clients 12. The clients 12 may be clustered about a plurality of network devices 14, such as hubs, routers and switches. The clients 12 and network devices 14 are collectively known as network nodes.

The network 10 may further be in communication with a wide area network 16 through a gateway 18. A collaboration server 20 includes database 22 such that the database 22 is accessible for storing information, is hereinbelow described, from any of the clients 12 and network devices 14 of the local area network 10.

Both cable and wireless connections may be used to interconnect the clients 12 and the network devices 14 in the network 10. Furthermore, some of the clients 12 may also be connected to the network 10 through virtual connections, such as virtual private network (VPN) tunnels and the like. Accordingly, the local area network 10 shall include any such network wherein the clients 12 may communicate between and among each other and share common resources irrespective of the manner in which any such client 12 communicates with the local network 10.

The collaboration bus protocol is resident on each node 12, 14 and operates in announcement, scanning, and active listening modes. In the announcement mode, each node 12, 14 continually broadcasts multi-cast messages to all the other network nodes 12, 14. The announcement function enables each node 12, 14 to communicate simultaneously with all the other nodes 12, 14 on the network 10, providing information about its identity, configuration parameters, perception of network status, and perceived failures. The scanning mode provides a mechanism for network nodes 12, 14 to listen for multicast messages and record the message content locally. Typically, all nodes 12, 14 may have the announcement and scanning modes activated. Accordingly, all nodes 12, 14 can maintain current real time information on the state of all other nodes 12, 14 and the status of the network 10. The scanned multicast messages contain node information that is written to hash tables, thereby assuring that only a small amount of data is needed to identify what each node 12, 14 sees and whether the network 10 are split. Furthermore, efficient parsing and validation of messages is assured.

In the active listening or “sniffing” mode, individual nodes 12, 14 monitor network traffic to identify packet types and spot specific kinds of traffic. Similarly to known intrusion detection systems, the active listening mode, the nodes 12, 14 spot patterns of packets that are reported as signatures to the collaboration server 20. The collaboration server 20 maintains a library of “registered” signatures with known interpretations in the database 22, and as new information about network conditions is learned, additional signatures can be registered. Building the library of registered signatures enables signatures that do not match any known signature to be flagged as representing a potential problem.

Signatures provide a way for all nodes 12, 14 to observe specific types of traffic that may not be destined for them. For example, an IGMP message from a router 14 to another node 12,14 indicating that the Internet is not reachable can be picked up by other nodes 12,14 for use in analyzing the current configuration of the network 10. Accordingly, it is possible to observe network usage and connections to the outside world. Security breaches can also be quickly identified any of the network nodes 12, 14.

Collaboration bus communications between nodes 12, 14 are based on a multicast point-to-point protocol that employs XML messages over any transport medium or transport protocol. Communications between nodes 12, 14 can also be established even in the absence of full TCP/IP connectivity. For example, a client 12 that has established operating system connectivity with its own network interface card with such card is physically attached to the network 10 is able to scan multicast messages on the network 10 using the collaboration bus protocol of the present invention. The client 12 is then able to collect the information needed from these messages to diagnose most connection and configuration problem at the client 12 or to establish its own TCP/IP protocol stack for full communications.

The XML multicast messages may include the following:

HELLO

ACKnowledged ResPonse REQuest

SIGnature spotted

NETwork ERRor

EVERYone RESpond

CONFiguration REQuest

REGister SIGnature (set)

REQuest ACTion

Goodbye.

Each HELLO message from a node 12, 14 contains a network summary that is written to hash tables on the other nodes 12, 14 when scanned and received. Accordingly, only a small amount of data is needed to identify what each node 12, 14 sees as the current state of the network 10. From such data, it can be determined whether the network 10 is split. The syntax assures efficient parsing and validation of messages.

The XML messages are contained in a Document Type Definitions (DTD) syntax tree, which describes all the valid messages. This structure has the advantage of storing the full set of valid messages for those nodes 12, 14 that require them, such as the clients 12, while storing a restricted set of messages as a branch of the tree for those embedded pieces of equipment in the network 10 that don't need to recognize the entire message set, such as a router 14. Each branch or subset of the syntax tree can be characterized as a role with an associated set of valid messages and a unique description for each. A role may be included in the HELLO message.

In addition to multicasting, the collaboration bus protocol also allows unicast messaging. Any node 12, 14 may send a particular message to any other node 12, 14. Also, configuration matching can be performed at any node 12, 14 by comparing the HELLO messages received from other ones of the nodes 12, 14. Still further, any node 12, 14 may multicast a message that contains information of the network 10 wherein such information has particular value to other ones of the nodes. For example, one node 12, 14 may see repeated timeouts, retransmissions, and collisions on the network 10. Such node 12, 14 may then multicast this information to all other nodes 12, 14, which may or may not be individually aware of such information.

The collaboration protocol, by using a common interface that is not hardware or software specific, may use such messages to request configuration status and to set configurations. For example, one node 12, 14 may be able to connect to the wide area network 16 through the gateway 18, whereas another one of the nodes 12, 14 is unable to do so. The node 12, 14 with the ability to connect may then be able to access the database 22 at the collaboration server 20 to diagnose the connectivity problem of the other node 12, 14. Furthermore, the node 12, 14 able to connect may then be able to download from the collaboration server 20 a software solution that it may then send to the node 12, 14 unable to connect through the gateway 18.

Since TCP/IP network connectivity cannot be assumed for configuration or diagnosis, the collaboration bus of the present invention employs a separate protocol that only requires connectivity from each client's 12 operating system to its network interface card. For problems of connectivity with the network interface card, the collaboration protocol may include diagnosis and repair of network driver problems.

With multiple perspectives provided by the collaboration bus, problems on the network 10 can be isolated much more accurately than with a single perspective. Collaboration also enables load sharing of repair functions. For example, if any one of the nodes 12, 14 can be used to implement a network repair function, performance of that function can be shifted to the node 12, 14 with the most available machines cycles.

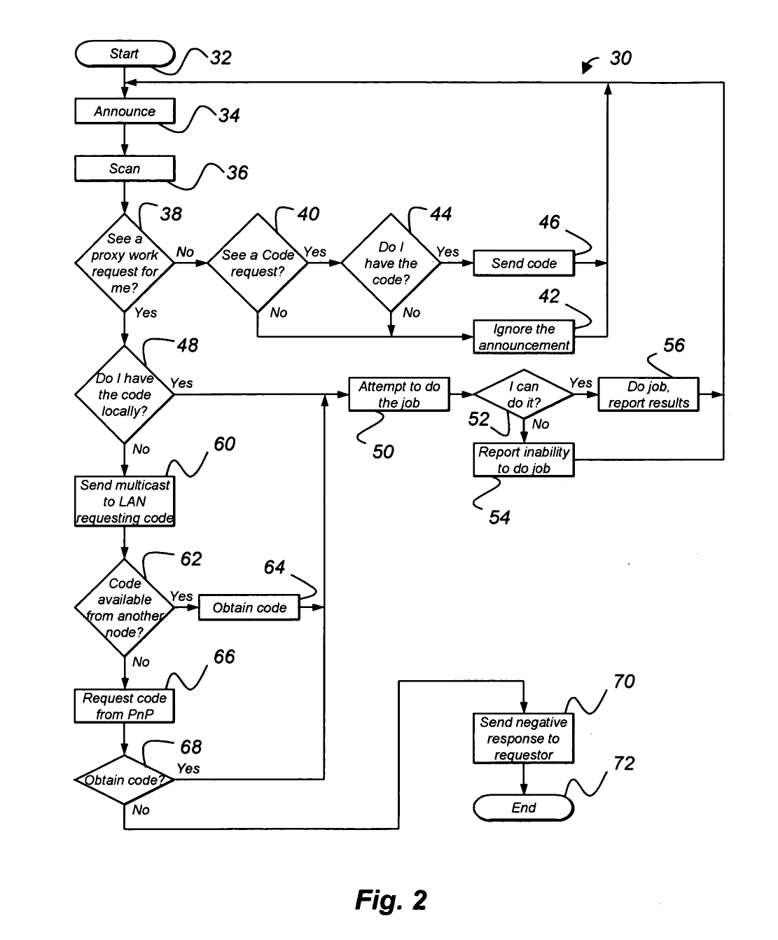

Referring now to FIG. 2, there is showing a flowchart 30 illustrative of collaboration bus process flow. Upon one of the clients 12 becoming active on the network 10, as indicated at 32, it announces its presence to the network 10 as indicated at 34. For example, a client 12 may announce its presence by multicasting a HELLO packet into the network 10. Furthermore, when the client 12 becomes active on the network 10, it also listens for other messages multicast into the network 10, as indicated at 36.

For example, from the scanned messages the client 12 determines if a proxy work request for such client 12 is present on the network 10, as indicated at 38. If it is determined at step 38 that there is not a proxy work request for the client 12, the NO path is taken to determine subsequently if one of the broadcast messages contains the code request for the client 12, as indicated at 40. If it is determined that there is no code request, the NO path is taken and the announcement is ignored, as indicated at 42.

If the client 12 does see a code request, at the determination step 40, it then must determine if it has the code, as indicated at 44. If it does not have the code, the NO path is taken and the announcement is ignored, as indicated at 42. If the client 12 does have the code, the YES path is taken and the code is sent to the requesting one of the clients 12, as indicated at 46. In either event, after ignoring the announcement at step 42 or sending the code at step 46, the execution path is returned to the announcement multicasting step 34. Accordingly, each client 12 is periodically announcing its presence to the network 10.

Returning to the determination step 38, if the client 12 does see a proxy work requests, the YES path is taken to determine if the client 12 has code locally stored to execute the proxy request, as indicated at 48. If the client 12 does have the code locally stored, the YES path is taken and the client 12 attempts to execute the code, as indicated at 50. A determination is made, as indicated at 52, whether the client 12 can execute the code. If not, the NO path is taken and the client 12 reports its inability to execute the code, as indicated at 54. If the determination at step 52 is positive, the YES path is taken and the client 12 executes the code and subsequently reports the results of the execution, as indicated at 56. In either event, after action being taken at steps 54 or 56, the execution path returns to the announcement step 34, such that the client 12 once again broadcasts a hello packet.

Returning to the decision step 48, if the client 12 does not have the code locally, it will broadcast into the network 10 a message requesting such code, as indicated at 60. A determination is made, at step 62, whether such code is available at another node, being ne of the clients 12, on the network 10. If such code is available, the code is obtained from such node, as indicated at 64, and the client 12 then attempts to execute the code as indicated at step 50 described above.

If the code is not available on the network 10, the NO path is taken and the client 12 may then request code from another node 12, 14 or from the collaboration server 20, as indicated at 66. A determination is made, is indicated that 68, whether the client 12 can obtain the code from the other node 12, 14 or from the collaboration server 20. If the code is available, the YES path is taken and the client attempts to execute the code as indicated at step 50 as described above. Otherwise, the NO path is taken and a negative response is returned to the client 12 as indicated 70. Execution may end, as indicated at step 72, and the client 12 may broadcast a further message to indicate it is disconnecting from the network 10.

Referring now to FIG. 3, there is shown a flowchart of an exemplary proxy work request that the client 12 may execute at step 56. When the client 12 begins execution of the proxy work request, as indicated at step 74, the client first checks for an intrusion detection system, as indicated at 76. As indicated at 78, a determination is made whether the intrusion detection system is present. If not, the NO path is taken in the client 12 sends a response indicating it cannot perform the task is indicated 80, and ends the process, at 82, and reports the results is indicated at step 56 of FIG. 2.

Otherwise, if the intrusion detection system is located, the YES path is taken to step 84. At step 84, the client 12 may, if necessary, register signatures and restarted the intrusion detection system. Such registration may be done by sending a message to the database 22 in the corroboration server 20. The intrusion detection system generates a signal spotted XML message. The client sends an acknowledgement, as indicated at 86, and ends the process, as indicated at 88. Upon such process being ended, the client 12 reports the results as indicated step 56 of FIG. 3.

There has been described above exemplary preferred embodiments of a collaboration bus apparatus and method. Those skilled in the art may now make numerous uses of, and departures from, the above-described embodiments without departing from the inventive principles disclosed herein. Accordingly the present invention is to be described solely by the lawfully permissible scope of the appended Claims.

What is claimed as the invention is:

1. A method of collaboration between clients of a local area network comprising steps of:
multicasting in said network a plurality of messages;
listening for said messages at each of said clients to detect which of said messages have reached each of said clients and recording at each of said clients which of said messages have been detected thereat;
comparing which messages have been detected at each of said clients to which messages have been detected at each other of said clients;
determining as a result of said comparing step a present inferred state of a configuration of said network as seen at each of said clients.

2. A method as set forth in claim 1 wherein said multicasting step includes sending said messages from a host external of said local area network.

3. A method as set forth in claim 2 wherein said sending step includes transmitting from said host to said network UDP packets.

4. A method as set forth in claim 1 wherein said multicasting step includes sending from each of said clients at least one respective one of said messages.

5. A method as set forth in claim 4 wherein said sending step includes transmitting from each of said clients a plurality of UDP packets to form each respective one of said messages.

6. A method as set forth in claim 4 wherein said sending step further includes transmitting from a VPN connected one of said clients at least one respective one of said messages.

7. A method as set forth in claim 6 further comprising the step of authenticating a VPN connection from said VPN connected one of said clients prior to said transmitting step.

8. A method as set forth in claim 1 further comprising the step of multicasting from each of said clients an information packet, each other of said clients further performing each of said listening step, said comparing step and said determining step with respect to said information packet.

9. A method as set forth in claim 8 wherein said information packet multicasting step includes multicasting said information packet on a periodic basis from at least one of said clients.

10. A method as set forth in claim 9 wherein said periodic multicasting step includes predetermining a time interval at which said periodic multicasting step is performed.

11. A method as set forth in claim 10 wherein said predetermining step includes setting said time interval at one of an observed failure rate and an expected failure rate of said at least one of said clients.

12. A method as set forth in claim 8 wherein said information packet multicasting step includes multicasting said information packet from at least one of said clients upon the occurrence of a predetermined event at said one of said clients.

13. A method as set forth in claim 8 wherein said information packet multicasting step includes multicasting said information packet from each of said clients only in the event of network traffic being below a predetermined threshold.

14. A method as set forth in claim 8 wherein said information packet multicasting step includes multicasting said information packet from each of said clients such that said information multicasting step is temporally distributed with respect to each of said clients.

15. A method as set forth in claim 8 wherein said information packet multicasting step includes multicasting said information packet includes multicasting said information packet from at least one of said clients

16. A method as set forth in claim 8 wherein said information packet multicasting step includes inserting into said packet an identifier uniquely identifying a multicasting one of said clients.

17. A method as set forth in claim 16 wherein said inserting step further includes inserting into said packet information concerning said present configuration as seen at said multicasting one of said clients.

18. A method as set forth in claim 17 wherein said present configuration inserting step includes inserting historical information relating to a multicasting one of said clients.

19. A method as set forth in claim 17 wherein said inserting step includes forming said information from a unique identifier of a multicasting one of said clients and a unique identifier of each other of said clients seen at said multicasting one of said clients.

20. A method as set forth in claim 19 wherein said forming step further includes forming said information from an IP address of said multicasting one of said clients and an IP address of each other of said clients seen at said multicasting one of said clients.

21. A method as set forth in claim 1 wherein said comparing step includes steps of:
transmitting from each of said clients a record of each of said messages detected thereat; and
receiving said record at each of said clients at a collaboration server, said determining step being performed at said collaboration server.

22. A method as set forth in claim 21 further comprising the step of connecting said collaboration server to said network through a WAN gateway.

23. A method as set forth in claim 21 further comprising the step of connecting said collaboration server to said network as one of said clients.

24. A method as set forth in claim 1 wherein said listening step is performed is performed only at a subset of said clients that have made a DNS requess within a selected time interval.

25. A method as set forth in claim 1 further comprising forming said messages with a grammatical tree structure such that selected ones of said clients may be associated with a respective branch of said tree, said selected ones of said clients performing said listening step for messages only on said respective branch.

26. A method as set forth in claim 25 wherein said forming step includes structuring said messages in XML.

27. A method as set forth in claim 25 said forming step includes defining said tree structure using a DTD and describing in said DTD a subset of said messages for use in an embedded device in said network.

28. A method as set forth in claim 27 further comprising filtering said messages at selected ones of said clients in accordance with said DTD.

29. A method as set forth in claim 28 wherein said filtering step includes defining role for a selected one of said clients such that said DTD is associated with said role.

30. A method as set forth in claim 29 further comprising inserting a role definition into an XML namespace of said messages.

31. A method as set forth in claim 1 further comprising steps of:
inserting into said messages a request for computation of code to be run at a selected one of said clients; and
running said code at said selected one of said clients.

32. A method as set forth in claim 31 wherein said running step includes authenticating said request, and loading said code at said selected one of said clients prior to running said code only in the event said request is authenticated.

33. A method as set forth in claimed 31 wherein said selected one of said clients performs an identified function in said network, said method further comprising steps of:
inserting into a message header of a message transmitted from said selected client information concerning said function;
filtering said messages transmitted into said network at said selected one of said clients by said function; and
loading code from one of said message transmitted into said network and a location specified in said message transmitted into said network into said selected one of said clients multicasting said function in said message.

34. A method as set forth in claim 1 further comprising steps of:
inserting into said messages for a selected one of said clients a pointer to code located at a server connected to said network through a WAN gateway;
requesting by said selected one of said clients to run said code;
running said code at said server; and
returning results of said running step to said selected one of said clients.

35. A method as set forth in claim 34 wherein said requesting step includes authenticating said request prior to said running step.

36. A method as set forth in claim 35 wherein said selected one of said clients performs an identified function in said network, said method further comprising steps of:
inserting into a message header of a message transmitted from said selected client information concerning said function;
filtering said messages transmitted into said network at said selected one of said clients by said function; and
loading code from said server into said selected one of said clients multicasting said function in said message 37. A method as set forth in claim 1 further comprising steps of:
identifying during said listening step one of pre-identified packet types, pre-identified content and pre-identified specific types of traffic to identify specific patterns; and
reporting said patterns from the identifying one of said clients to all other of said clients.

38. A method as set forth in claim 37 wherein said identifying step includes choosing said patterns in accordance with an association of said patterns to states of said network.

39. A method as set forth in claim 37 to further comprising registering said patterns in a database accesible to said network.

40. A method as set forth in claim 39 further comprising the step of installing said database at a selected one of said clients.

41. A method as set forth in claim 39 further comprising the step of installing said database at a server connected to said network through a WAN gateway.

42. A method as set forth in claim 39 wherein said registering step includes assigning a name for said pattern and inserting said name in an XML namespace.

43. A method as set forth in claim 37 wherein said identifying step includes extracting from said packets information concerning a state of said network at non-addressed ones of said clients.

44. A method as set forth in claim 43 further comprising multicasting from one of said non-addressed ones of said clients said information concerning said state of said network in the event of one of an occurrence of a predefined event, a non-occurrence of an expected event and a change in observed patterns identified at said non-addressed one of said clients.

45. A method as set forth in claim 43 further comprising transmitting from one of said non-addressed ones of said clients to an addressed one of said clients said information concerning said state of said network in the event of one of an occurrence of a predefined event, a non-occurrence of an expected event and a change in observed patterns identified at said non-addressed one of said clients.

46. A method as set forth in claim 1 further comprising steps of:
multicasting from each of said clients a message containing information of said state of said present configuration of said network as determined at a multicasting one of said clients;
receiving at each other of said clients messages broadcast from each of said clients;
comparing at said multicasting one of said clients said information in said message broadcasted from said multicasting one to said information in said messages received from each other of said clients; and
identifying at said multicasting one of said clients an anomaly existing in one of said clients with respect to said information in all of said messages.

47. A method as set forth in claim 46 further comprising the step of further multicasting from said multicasting one of said clients information concerning said anomaly to others of said clients.

48. A method as set forth in claim 47 further comprising the step of sending from one of said clients having information of said anomaly a request to execute corrective action at said one of said clients in which said anomaly exists.

49. A method of collaboration between clients of a local area network comprising steps of:
passively monitoring at each of a plurality of nodes on a network packets being transmitted on said network;
recognizing at each of said nodes predetermined patterns within said packets;
generating at each of said nodes a report based on a recognized one of said patterns;
comparing each of said reports for similarity;
in the event one of said reports is indicative of an anomaly, accessing a knowledge base of corrective action; and
performing corrective action at one of said nodes at which said one of said reports is indicative of said anomaly.

50. A method as set forth in claim 49 wherein said accessing step is repeatedly performed until said anomaly is mitigated.

51. A method as set forth in claim 49 wherein said performing step includes re-configuring network protocols at said one of said nodes.

52. A method as set forth in claim 49 wherein said performing step includes re-configuring network protocols at a selected one of said nodes remotely from said one of said nodes.

53. A method as set forth in claim 49 further comprising installing said knowledge base at a selected one of said nodes.

54. A method as set forth in claim 53 further comprising updating said knowledge base with information respecting said anomaly.

55. A method as set forth in claim 49 wherein said accessing step includes steps of:
searching said knowledge base using said pattern as search criteria, and
recalling from said knowledge base items in which said pattern is an exact match.

56. A method as set forth in claim 55 wherein said recalling step further includes recalling from said knowledge base items in which said pattern is a closest possible match in the event said exact match does not exist.

57. A method as set forth in claim 56 further comprising, in the event said anomaly is mitigated from use of one of said items from said closest possible match, the step of updating said knowledge base with information of the mitigation.

58. A method as set forth in claim 49 further comprising the step of injecting packets into said network, said recognizing step being performed to define patterns for population of said knowledge base.

59. A method of collaboration between clients of a local area network comprising steps of:
multicasting from each of said clients a HELLO message into said network, each of said HELLO messages containing network configuration information of said network as determined by a multicasting one of said clients;
receiving at each of said clients said HELLO message broadcast by other ones of said clients;
confirming at each receiving one of said clients a likeness of said network configuration information broadcasted by said receiving one with said network configuration information from said HELLO messages received at said receiving one of said clients.

60. A method as set forth in claim 59 further comprising a step of transmitting from said receiving one of said clients a further message in the event likeness of said network configuration information broadcasted by said receiving one is indicative of an anomaly to said network configuration information from one of said HELLO messages received at said receiving one, said further message containing information of said anomaly.

61. A method as set forth in claim 60 wherein said transmitting step includes transmitting said further message to one of said clients having broadcasted said one of said HELLO messages.

62. A method as set forth in claim 60 wherein said transmitting step includes steps of:
transmitting said further message to a selected one of said clients; and
registering in a database at said selected one of said clients said information of said anomaly.

63. A method as set forth in claim 62 further comprising steps of:
determining in response to receipt of said further message at said selected one of said clients an error in said network configuration as seen at one of said clients;
sending from said selected one of said clients to one of said clients in which said error exists a request message; and
executing a procedure at said one of said clients in which said error exists in accordance with said request message.

64. A method as set forth in claim 60 wherein said transmitting step includes multicasting said further message to all other of said clients.

65. A method as set forth in claim 59 further comprising steps of:
monitoring at each of said clients packets being transmitted on said network;
detecting a predetermined pattern in said packets; and
multicasting from a detecting one of said clients a message advising each other of said clients of said detection of said pattern.

66. A method as set forth in claim 65 further comprising registering in a database at said selected one of said clients said detection of said pattern.

67. A method as set forth in claim 59 further comprising steps of:
multicasting from at least one of said clients into said network a message requesting certain action;
receiving said message requesting certain action at other ones of said clients; and
performing at each receiving one of said clients said action.

68. A method as set forth in claim 67 wherein said performing step includes multicasting from said receiving one a configuration of said receiving one.

69. A method as set forth in claim 67 wherein said performing step includes multicasting from said receiving one an acknowledgement of said receiving one.

70. A method as set forth in claim 67 wherein said performing step includes executing code at said receiving one.

71. A method as set forth in claim 59 further comprising a step of multicasting a termination message from one of said clients in the event said one of said clients is in the process of being logged off from said network.
